(19) United States
(12) Patent Application Publication
(10) Pub. No.: US 2026/0056819 A1
(43) Pub. Date: Feb. 26, 2026

(54) STORAGE MEDIUM, INFORMATION PROCESSING APPARATUS, AND CONTROL METHOD

(71) Applicant: CANON KABUSHIKI KAISHA, Tokyo (JP)

(72) Inventor: Yusuke MATSUI, Tokyo (JP)

(21) Appl. No.: 19/293,077

(22) Filed: Aug. 7, 2025

(30) Foreign Application Priority Data
Aug. 20, 2024 (JP) 2024-138884

(51) Int. Cl. G06F 11/07; G06F 8/61

(52) U.S. Cl. CPC G06F 11/0766; G06F 8/61

(57) ABSTRACT

A non-transitory computer readable storage medium in the present disclosure stores a program for installing, in an information processing apparatus, specific software for providing a print function different from that by OS having a function of setting whether to enable a specific print mode as OS's function, and a function of restricting specific software installation in a case where the specific print mode is set to be enabled, the program causing a computer to function to install the specific software in a case where an operation for specific software installation is performed by a user and the specific print mode is set to be disabled, and function to display a specific notification on a restriction on the specific software in a case where the operation for installing the specific software is performed by a user and the specific print mode is set to be enabled.

### BACKGROUND

### Field of the Technology

The present disclosure relates to a device driver installing technique.

### Description of the Related Art

There is an automatic update system with which a computer, such as a PC (personal computer), executes an OS version upgrade by receiving new OS (operating system) update information from an OS distribution server or the like to which the computer is connected via a network, such as the Internet. An example of the automatic update system may be Windows Update or the like. In a case where the version OS is upgraded by such an automatic update system, the OS after the version upgrade may possibly be an OS that restricts the installation of a device driver (“vendor driver”) provided by a third party, such as a vendor of a device. In this case, if a user tries to install a vendor driver supporting an old architecture by using an installer for the device driver (hereinafter also simply called “driver”), the vendor driver may not be installed. In this case, the user feels as if the installation of the device driver is suddenly disabled, and it is difficult for the user to specify the cause.

Japanese Patent Laid-Open No. 2017-162106 (hereinafter called “Patent Literature 1”) discloses a technique where if the installation of a certain version of a driver in the OS fails, a message indicating the cause is output to notify a user. Specifically, the technique disclosed in Patent Literature 1 refers to the date in a case where the driver was created, and estimates that the cause of the failure is restriction on the installation of the version of the driver by the OS.

### SUMMARY

The inventor have found that there is a possibility that with a version of OS or a newly provided OS in consideration of a certain OS, the installation of a vendor driver provided by a third party that is a vendor other than the OS vendor is hereafter restricted irrespective of the version of the driver. The inventor have found that there is a possibility that the operation of the installed vendor driver is stopped. For example, with Windows (R), which is an OS provided by Microsoft Corp., a new print mode called WPP (Windows Protected Print Mode) is planned to be introduced. The WPP has a function of restricting the installation of a vendor driver for a printer (hereinafter called “vendor printer driver”) provided by a third party, such as a printer vendor, and a function of stopping the operation of the installed vendor printer driver.

In a case where the WPP is in the enabled state, printing is allowed only in a case of using an OS-embedded IPP (Internet Printing Protocol) class driver (hereinafter called “standard printer driver”). If it is insufficient only with the function of the standard printer driver, a PSA (Print Support Application) provided by a third party is automatically set up through Microsoft Store.

In a case where the WPP is in the disabled state as a default state, the user is required to activate a group policy manager and edit the WPP setting in order to change the state to the enabled state. In a case where the WPP is in the disabled state as the default state, the vendor printer driver may be installed unless the state is changed to the enabled state by user. However, the inventor have found that the design might be changed so as to make the WPP enabled in the default state due to a future OS version upgrade or the like. In such a case, the inventor have found that since the WPP might be enabled irrespective of the user's intention, the user might feel that the vendor printer driver installation suddenly becomes impossible, and it is difficult for the user to specify the cause.

The present disclosure has been made in view of the problem described above, and is directed to provide a technique allowing a user to suitably perform an operation in an environment where a restriction pertaining to the vendor driver by an OS setting is applied.

A non-transitory computer readable storage medium according to the present disclosure stores a program for installing specific software for providing a print function different from a print function by an operating system that has a setting function of setting whether to enable a specific print mode as a function of the operating system, and a restriction function of restricting installation of software for providing the print function different from the print function by the operating system in a case where the specific print mode is set to be enabled, wherein the program causes at least one computer to function as a control unit configured to perform control to install the specific software in the information processing apparatus in a case where an operation for installing the specific software is performed by a user and the specific print mode is set to be disabled, and perform control to display a specific notification on a restriction relating to the specific software in a case where the operation for installing the specific software is performed by a user and the specific print mode is set to be enabled.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram showing an example of a configuration of a system according to the present disclosure;

FIG. 2 is a block diagram showing an example of a hardware configuration of a PC according to the present disclosure;

FIG. 3 is a block diagram showing an example of a hardware configuration of a device according to the present disclosure;

FIG. 4 is a block diagram showing an example of a configuration of software pertaining to the device according to an embodiment 1;

FIGS. 5A to 5C are diagrams showing examples of UI screens according to the embodiment 1;

FIGS. 6A to 6C are diagrams showing examples of warning notification dialogs according to the embodiment 1;

FIGS. 7A and 7B are flowcharts showing examples of the flow of an installation process using an installer according to the embodiment 1;

FIG. 8 is a flowchart showing an example of the flow of an installation process using an installer according to an embodiment 2;

FIG. 9 is a flowchart showing an example of the flow of the installation process using the installer according to the embodiment 2;

FIG. 10 is a diagram showing an example of a warning notification dialog according to an embodiment 3;

FIG. 11 is a flowchart showing an example of an installation process using an installer according to the embodiment 3;

FIG. 12A is a flowchart showing an example of a processing flow of a driver installation unit according to the embodiment 3, FIG. 12B is a flowchart showing an example of a processing flow of an icon generating unit, and FIG. 12C is a flowchart showing an example of a processing flow of an application installation unit;

FIG. 13 is a block diagram showing a configuration of a setup application that supports a device according to an embodiment 4;

FIGS. 14A to 14E are diagrams showing examples of UI screens according to the embodiment 4;

FIG. 15 is a flowchart showing an example of a processing flow from activation to completion of the setup application according to the embodiment 4;

FIG. 16 is a diagram showing an example of a UI screen according to an embodiment 5;

FIG. 17 is a flowchart showing an example of a processing flow from activation to completion of the setup application according to the embodiment 5;

FIG. 18 is a block diagram showing an example of a configuration of software pertaining to a device 102 according to an embodiment 6;

FIG, 19 is a diagram showing an example of a warning notification dialog according to the embodiment 6;

FIG. 20 is a flowchart showing an example of a processing flow from activation to completion of an installer according to the embodiment 6; and

FIG. 21 is a flowchart showing an example of a processing flow of a resident application according to the embodiment 6.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. Incidentally, an identical reference numeral is assigned to an identical constituent and an explanation thereof is made.

### Embodiment 1

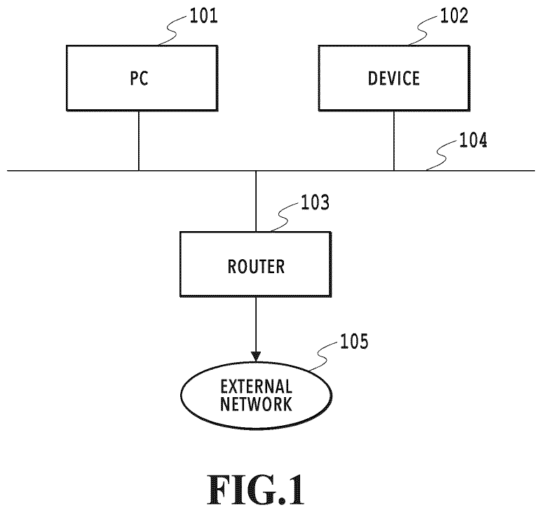

FIG. 1 is a block diagram showing an example of a configuration of a system according to an embodiment 1. In the system shown in FIG. 1, a PC 101, a device 102, and a router 103 are connected to each other via a network 104 to allow communication. These communicate in accordance with the TCP/IP (Transmission Control Protocol/Internet Protocol) protocol and UDP. The network 104 is connected to an external network 105 via the router 103 to allow communication. The PC 101 is an example of an information processing apparatus according to the present disclosure. The PC 101 is not limited to a personal computer.

The device 102 is a peripheral device, such as a printer, a copier, a facsimile, or a scanner, or a device that has multiple functions as functions that such a peripheral device has. The device 102 supports the TCP/IP protocol. The device 102 also supports: the WSD (Web Services on Devices) protocol, which is a standard network protocol of Windows and supports UPnP (Universal Plug and Play); and the LLMNR (Link-Local Multicast Name Resolution) protocol, which can resolve the names of neighboring network devices. The WSD function and the LLMNR function of the device 102 may be enabled or disabled by a user directly operating the device 102. The router 103 has a DHCP (Dynamic Host Configuration Protocol) server function, and allocates IP addresses to the PC 101 and the device 102.

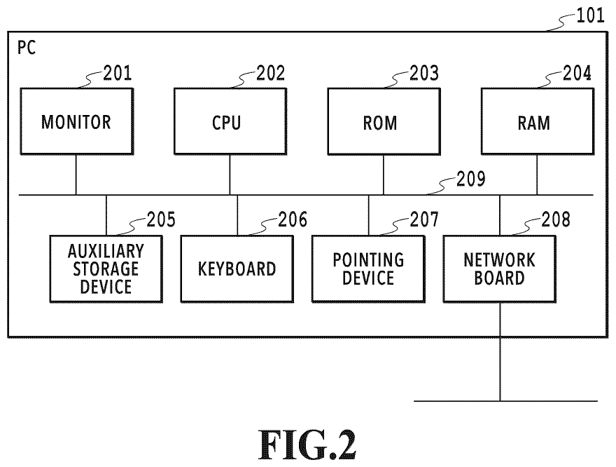

FIG. 2 is a block diagram showing an example of the hardware configuration of the PC 101 according to the embodiment 1. The PC 101 includes a monitor 201, a CPU 202, a ROM 203, a RAM 204, an auxiliary storage device 205, a keyboard 206, a pointing device 207, and a network board 208. The hardware components included in the PC 101 are connected to each other via a bus 209 to allow communication. The monitor 201 displays installation application software (hereinafter called “installer”), and the UI (User Interface) of a driver. The CPU 202 loads, into the RAM 204, programs, such as the installer and the driver that are stored in the ROM 203 or the auxiliary storage device 205, and executes the loaded programs. The ROM 203 stores basic software, such as BIOS, and various programs for implementing processes that are to be executed in the PC 101. The RAM 204 is used as a work area for the CPU 202, and temporarily stores data utilized by software (programs), such as the installer and the driver, and data utilized by the software.

The auxiliary storage device 205 is made up of a hard disk drive or the like. The auxiliary storage device 205 stores software (programs), such as the OS, installer, drivers, and various modules. The drivers that the auxiliary storage device 205 stores include device drivers, such as a scanner driver, a printer driver, and a facsimile driver, for controlling the device 102. The drivers that the auxiliary storage device 205 stores include a display control driver that controls display on the monitor 201, a keyboard driver that controls the keyboard 206, and a pointing device driver that controls the pointing device 207. Furthermore, the drivers that the auxiliary storage device 205 stores include a network driver that controls the communication of the network board 208.

The installer that the auxiliary storage device 205 stores has a search function for the device 102 over TCP/IP. Alternatively, the search function may be implemented by the installer invoking and executing a module that has the search function. The keyboard 206 and the pointing device 207 are operation and input devices that accept an operation from the user, and input a signal corresponding to the operation into the CPU 202. The network board 208 communicates with the device 102 via the network 104.

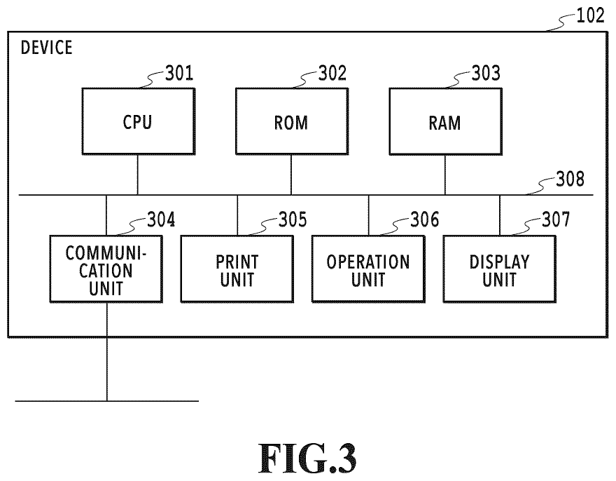

FIG. 3 is a block diagram showing an example of the hardware configuration of the device 102 according to the embodiment 1. Specifically, FIG. 3 shows an example of the hardware configuration in the case where the device 102 is a printer. The device 102 includes a CPU 301, a ROM 302, a RAM 303, a communication unit 304, a print unit 305, an operation unit 306, and a display unit 307. The hardware components that constitute the device 102 are connected to each other via the bus 308 in a way to allow communication. The CPU 301 is, for example, a microprocessor. The CPU 301 functions as a central processing unit of the device 102. The CPU 301 loads programs stored in the ROM 302 into the RAM 303, and executes the loaded programs, thereby controlling the communication unit 304, the print unit 305, the operation unit 306, and the display unit 307. The ROM 302 stores various programs for implementing processes that are to be executed by the device 102. The RAM 303 is used as a work area for the CPU 301, and temporarily stores various data items utilized by the various programs.

The communication unit 304 communicates with another device 102 via the network 104. The print unit 305 prints image data on a print medium, such as paper, for example. The operation unit 306 is made up of an operation and input device, such as buttons or a touch panel. The display unit 307 displays screens for operating the device 102, and various types of information about the device 102. Note that in a case where the device 102 is a device other than the printer, the device 102 includes another hardware component instead of the print unit 305 or in addition to the print unit 305. For example, in a case where the device 102 is a scanner, the device 102 includes, as another hardware component, a reading unit that reads images formed on documents.

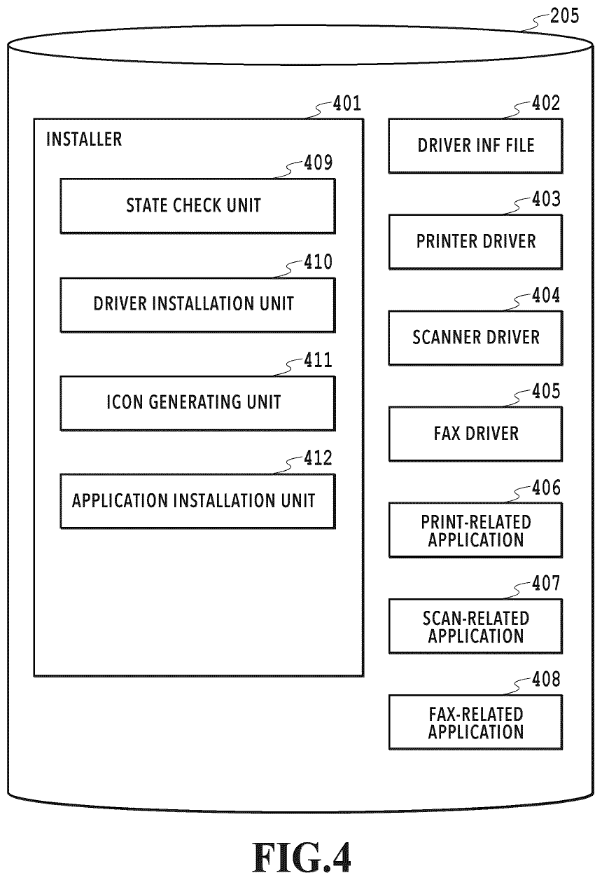

FIG. 4 is a block diagram showing an example of software that pertains to the device 102 and is stored in the auxiliary storage device 205 that the PC 101 according to the embodiment 1 includes. As shown as an example in FIG. 4, the auxiliary storage device 205 that the PC 101 includes stores an installer 401, a driver INF file 402, a vendor driver, and application software related to the device 102. Description is made below with the application software being called “device-related application”. Specifically, the auxiliary storage device 205 stores a printer driver 403, a scanner driver 404, and a fax driver 405, as vendor drivers. The auxiliary storage device 205 stores a print-related application 406, a scan-related application 407, and a fax-related application 408, as the device-related applications.

The installer 401 is executed by the CPU 202, thereby searching the device 102 connected to the PC 101, and allowing the monitor 201 to display information related to the device 102 detected by the search. The installer 401 is a driver installer for installing, in the PC 101, the vendor driver for the device 102 corresponding to a piece of information selected by the user from among the displayed pieces of information. The driver INF file 402 stores information indicating the model type of the device 102 corresponding to at least one of the printer driver 403, the scanner driver 404, and the fax driver 405, which will be installed by execution of the installer 401.

The installer 401 includes a state check unit 409, a driver installation unit 410, an icon generating unit 411, and an application installation unit 412, as functional components. Each of the components included as the functional components in the installer 401 shown in FIG. 4 as an example is implemented by the CPU 202 included in the PC 101 reading and executing the installer 401 stored in the auxiliary storage device 205. In the present embodiment, through execution of the CPU 202, the installer 401 searches for the device 102 that is present in the same network 104, and displays the device 102 detected by the search on the monitor 201. On the other hand, if no device 102 present in the same network 104 is detected, the installer 401 displays, on the monitor 201, a notification indicating that even a single device has not been detected.

The state check unit 409 specifies whether the setting for restricting the installation of the vendor driver is in an enabled state or a disabled state irrespective of the version of the driver, in the OS of the PC 101. A case where the OS of the PC 101 is Windows provided by Microsoft Corp., and the setting is a setting indicating whether WPP is enabled or disabled is described below as an example. That is, in the present embodiment, the state check unit 409 specifies whether the WPP is in the enabled state or the disabled state.

The driver installation unit 410 installs the vendor driver in the PC 101. Note that the driver installation unit 410 may select the vendor driver to be installed in the PC 101, with respect to the type of the device 102. For example, in a case where the device 102 is a printer, the installer 401 installs the printer driver 403 in the PC 101. Alternatively, in a case where the device 102 is a scanner, the installer 401 installs the scanner driver 404 in the PC 101. Further alternatively, in the case where the device 102 is an MFP (Multi-Function Printer), the installer 401 installs at least one of the printer driver 403, and the scanner driver 404 and the fax driver 405, in the PC 101.

The icon generating unit 411 generates a device icon associated with the device 102. Note that the icon generating unit 411 may change the device icon to be generated, depending on the type of the device 102. The installer 401 associates the device icon generated by the icon generating unit 411 with the vendor driver installed by the installer 401, and installs the icon in the PC 101. For example, in a case where the device 102 is a printer, the icon generating unit 411 generates a printer icon. Alternatively, in a case where the device 102 is a scanner, the icon generating unit 411 generates a scanner icon. Further alternatively, in a case where the device 102 is an MFP, the icon generating unit 411 generates at least one of a printer icon, and a scanner icon and a fax icon.

The application installation unit 412 installs application software (device-related application) related to the device 102. The device-related application includes application software, such as the print-related application 406, the scan-related application 407, and the fax-related application 408. Note that the application installation unit 412 may select the device-related application to be installed, with respect to the type of the device 102. For example, in the case where the device 102 is a printer, the application installation unit 412 installs the print-related application 406 in the PC 101. Alternatively, in the case where the device 102 is a scanner, the application installation unit 412 installs the scan-related application 407 in the PC 101. Further alternatively, in the case where the device 102 is an MFP, the application installation unit 412 installs the print-related application 406 and the scan-related application 407 in the PC 101.

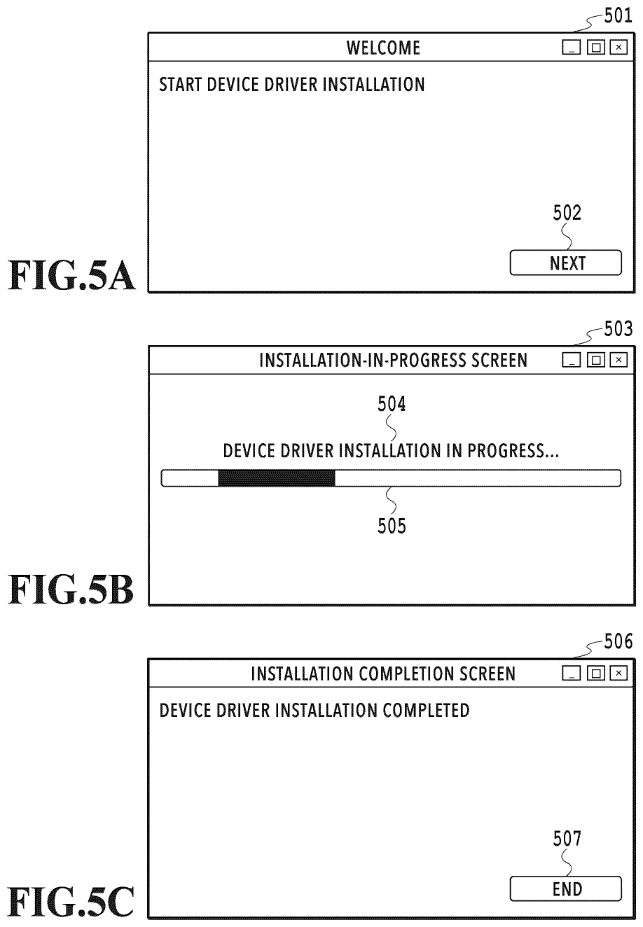

FIGS. 5A to 5C are diagrams showing examples of UI screens according to the embodiment 1. Specifically, FIG. 5A shows an example of an initial activation screen 501 displayed on the monitor 201 in a case where the installer 401 is activated by the CPU 202. FIG. SB shows an example of a UI screen displayed in a state where at least one of the driver installation unit 410, the icon generating unit 411, and the application installation unit 412 is executed by the CPU 202 executing the installer 401. An installation-in-progress screen 503 shown in FIG. SB is displayed instead of the initial activation screen 501 in a case where a button 502 on the initial activation screen 501 is clicked by the user.

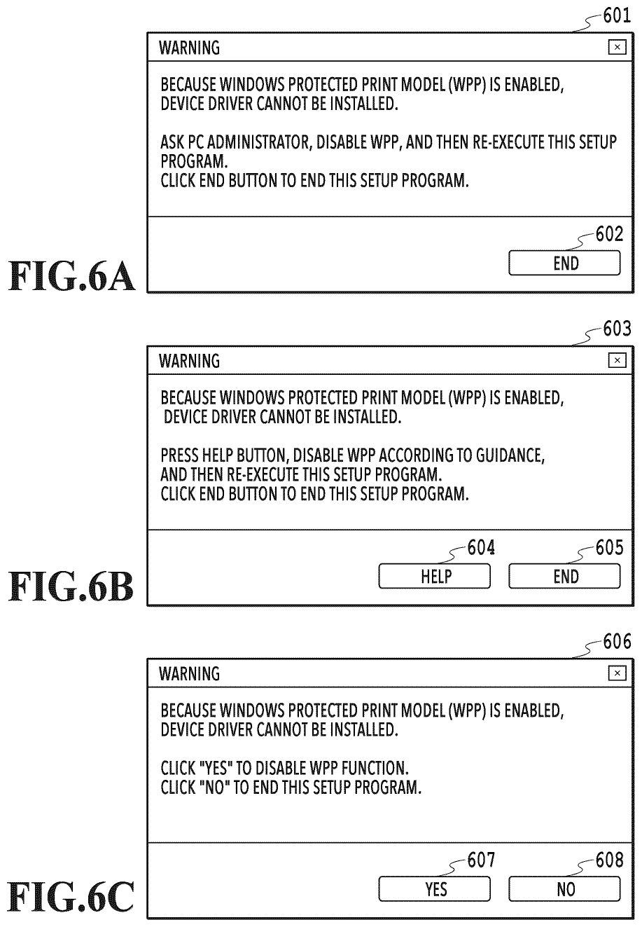

After the installer 401 is activated by the CPU 202, the installer 401 executes the process of the state check unit 409 before the initial activation screen 501 is displayed. If it is specified that the WPP is in a disabled state as a result of a check process by the state check unit 409, the installer 401 displays the initial activation screen 501. On the other hand, if it is specified that the WPP is in an enabled state as a result of the check process by the state check unit 409, the installer 401 displays, on the monitor 201, a warning notification dialog indicating that the WPP is in the enabled state. An aspect of the warning notification dialog is described later with reference to FIGS. 6A to 6C.

The installation-in-progress screen 503 includes an internal process status 504 that is an area for indicating the status of the internal process. For example, while the installer 401 is executing the process of the driver installation unit 410, a message, such as “DRIVER INSTALLATION IN PROGRESS . . . ”, and a progress bar 505 are displayed at the internal process status 504. FIG. SC shows an example of a UI screen displayed in a case where each of various installation processes by the installer 401 is completed. In a case where a button 507 on an installation completion screen 506 shown in FIG. 5C is clicked by the user, the installer 401 closes the installation completion screen 506, and ends the predetermined installation process.

FIGS. 6A to 6C are diagrams showing examples of waring notification dialogs displayed on the monitor 201 according to the embodiment 1. FIG. 6A shows an example of a warning notification dialog 601 displayed on the monitor 201 in a case where the WPP is specified to be in the enabled state as the result of the check process by the state check unit 409. The warning notification dialog 601 shown in FIG. 6A includes messages for notifications for indicating that a desired driver cannot be installed because the WPP is in the enabled state, and for a workaround that may be taken to install the driver. In a case where a button 602 in the waring notification dialog 601 is clicked by the user, the installer 401 closes the warning notification dialog 601, and ends the predetermined installation process.

FIG. 6B shows an example of a warning notification dialog 603 displayed on the monitor 201 in a case where the WPP is specified to be in the enabled state as the result of the check process by the state check unit 409. The warning notification dialog 603 shown in FIG. 6B includes a message for a notification indicating that a desired driver cannot be installed because the WPP is in the enabled state. The warning notification dialog 603 includes a message for guiding a method of displaying a workaround that may be taken to install the driver. In a case where a button 604 in the warning notification dialog 603 is clicked by the user, the installer 401 displays a webpage indicating a method of changing the setting from the WPP-enabled state to the disabled state. In a case where a button 605 in the warning notification dialog 603 is clicked by the user, the installer 401 closes the waring notification dialog 603, and ends the predetermined installation process.

FIG. 6C shows an example of a warning notification dialog 606 displayed on the monitor 201 in a case where the WPP is specified to be in the enabled state as the result of the check process by the state check unit 409. The warning notification dialog 606 shown in FIG. 6C includes a message for a notification indicating that the desired driver cannot be installed because the WPP is in the enabled state. The warning notification dialog 606 includes a message for guiding a user operation to allow the installer 401 to change the setting from the WPP-enabled state to the disabled state. In a case where a button 607 in the warning notification dialog 606 is clicked by the user, the installer 401 closes the warning notification dialog 606, changes the setting from the WPP-enabled state to the disabled state, and subsequently, displays the initial activation screen 501. In a case where a button 608 in the warning notification dialog 606 is clicked by the user, the installer 401 closes the warning notification dialog 606, and ends the predetermined installation process.

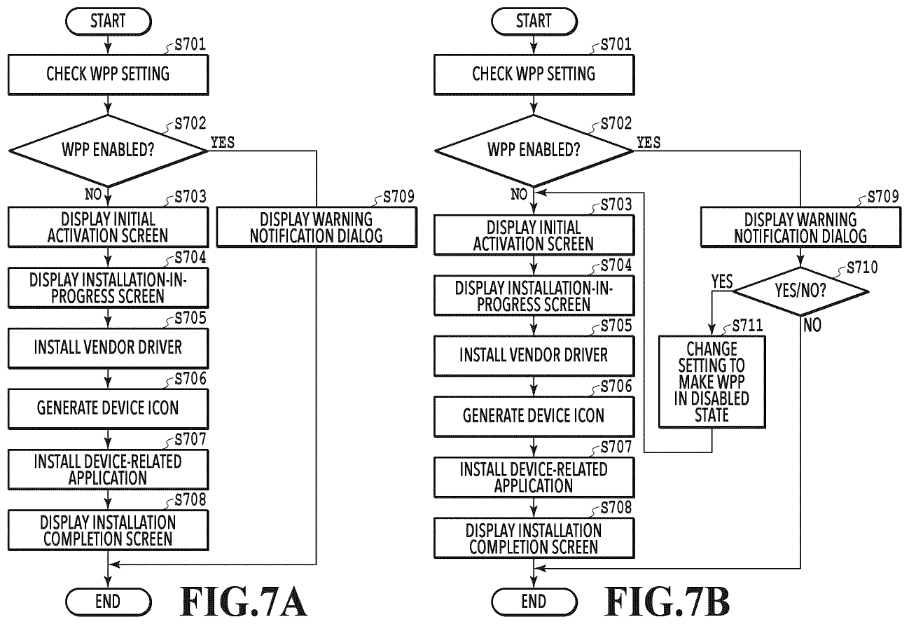

FIGS. 7A and 7B are flowcharts showing examples of the flow of the installation process using the installer 401 in the PC 101 according to the embodiment 1. Specifically, the flowchart shown in FIG. 7A shows an example of a processing flow of the installer 401 in a case where the warning notification dialog 601 or 603 is displayed in a case where the WPP is specified to be in the enabled state by the state check unit 409. The process of the flowchart is started by the CPU 202 activating the installer 401 based on an operation by the user.

In S701, the CPU 202 checks the WPP setting, and specifies whether the WPP is in the enabled state or the disabled state. Note that the check process of S701 is implemented by the CPU 202 executing the state check unit 409 included in the installer 401. In S702, the CPU 202 determines whether the WPP is in the enabled state or not based on the result of the check process of S701. If it is determined that the WPP is in the enabled state (YES), the processing proceeds to S709. If it is determined otherwise (NO), the processing proceeds to S703. In S703, the CPU 202 displays the initial activation screen 501 shown in FIG. 5A. Subsequently, the CPU 202 stands by until the button 502 on the initial activation screen 501 is clicked by the user. In a case where the button 502 on the initial activation screen 501 is clicked by the user, the processing proceeds to S704. In S704, the CPU 202 displays the installation-in-progress screen 503 shown in FIG. 5B instead of the initial activation screen 501.

In S705, the CPU 202 installs the vendor driver. Note that the process of the installation in S705 is implemented by the CPU 202 executing the driver installation unit 410 included in the installer 401. In S706, the CPU 202 generates the device icon. Note that the generating process of S706 is implemented by the CPU 202 executing the icon generating unit 411 included in the installer 401. In S707, the CPU 202 installs the device-related application. Note that the process of the installation in S707 is implemented by the CPU 202 executing the application installation unit 412 included in the installer 401. In S708, the CPU 202 displays the installation completion screen 506 shown in FIG. 5C instead of the installation-in-progress screen 503. In a case where the button 507 on the installation completion screen 506 is clicked by the user, the CPU 202 closes the installation completion screen 506, and ends the process of the flowchart shown in FIG. 7A, i.e., the execution of the installer 401.

In S709, the CPU 202 displays the warning notification dialog 601 or 603. In a case where the button 602 or 605 in the warning notification dialog 601 or 603 is clicked by the user, the CPU 202 closes the displayed warning notification dialog 601 or 603, and ends the process of the flowchart shown in FIG. 7A, i.e., the execution of the installer 401.

Specifically, the flowchart shown in FIG. 7B shows an example of a processing flow from activation to completion of the installer 401 in a case where a warning notification dialog 606 shown in FIG. 6C is displayed in a case where the WPP is specified to be in the enabled state by the state check unit 409. The process of the flowchart is started by the CPU 202 activating the installer 401 based on an operation by the user. In the description of FIG. 7B, steps for performing the same processes as the processes in the flowchart shown in FIG. 7A are assigned the same reference signs, and the description thereof is omitted. That is, the description from S701 to S708 shown in the flowchart of FIG. 7B is omitted.

In S709, the CPU 202 displays the warning notification dialog 606. The CPU 202 stands by until the button 607 or 608 in the warning notification dialog 606 is clicked by the user. In S710, the CPU 202 determines whether the button 607 is clicked or the button 608 is clicked in the warning notification dialog 606 by the user. If it is determined that the button 607 (YES) is clicked, the processing proceeds to S711. If it is determined that the button 608 (NO) is clicked, the CPU 202 closes the warning notification dialog 606, and ends the process of the flowchart shown in FIG. 7B, i.e., the execution of the installer 401. In S711, the CPU 202 closes the warning notification dialog 606, and changes the setting from the WPP-enabled state to the disabled state. After S711, the CPU 202 executes the processes from S703 to S708.

As described above, it is configured such that before the vendor driver is installed, it is checked whether the WPP is in the enabled state, i.e., whether to be in the state where the installation of the vendor driver is restricted irrespective of the version by the OS setting. Accordingly, if the vendor driver cannot be installed, a notification indicating that the cause is the state where the installation of the vendor driver is restricted irrespective of the version by the OS setting may be issued to the user. It is also configured to check with the user whether to change the setting from the state where the installation is restricted to the state where the installation is allowed. Accordingly, the setting may be changed by the user's own decision to the state where the installation is allowed, and after the change to the state where the installation is allowed, the vendor driver may be installed.

Note that the check process of the WPP setting by the state check unit 409 is performed by obtaining information on the WPP setting using the API (Application Programming Interface) provided by Windows. The method of the check process is not limited to use of the API. For example, the check process of the WPP setting by the state check unit 409 may be performed by obtaining the value of a predetermined registry pertaining to the WPP setting.

### Embodiment 2

An embodiment 2 will be described mainly on points different from those in the embodiment 1. The installer 401 according to the embodiment 1 includes the state check unit 409 that specifies whether the WPP is in the enabled state or the disabled state. In contrast, the installer 401 according to the present embodiment determines whether the WPP is in the enabled state or the disabled state, in the vendor driver installation process or the generation process for the device icon with which the vendor driver is associated. Note that in the description of the present embodiment, the same components as those in the embodiment 1 are assigned the same reference symbols, and the description thereof is omitted.

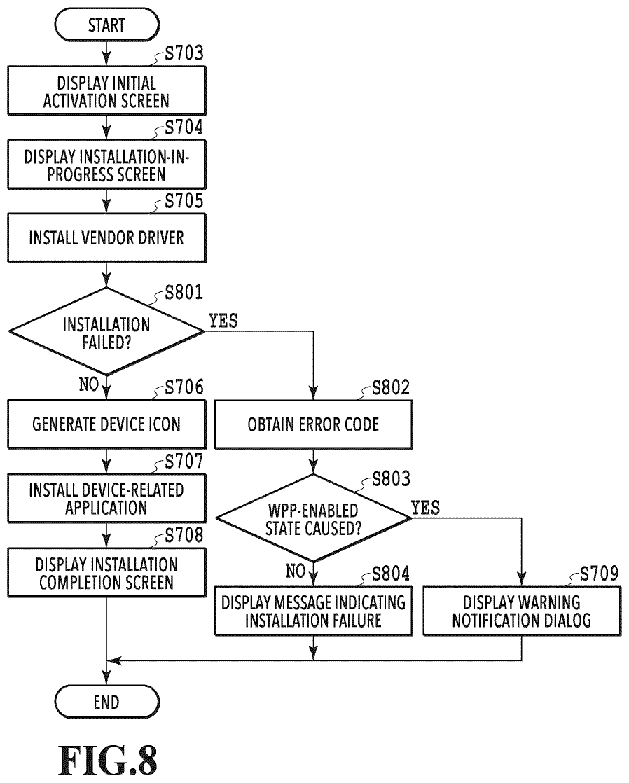

FIG. 8 is a flowchart showing an example of the flow of an installation process using the installer 401 in the PC 101 according to the embodiment 2. Specifically, the flowchart shown in FIG. 8 shows an example of a processing flow from activation to completion of the installer 401. The process of the flowchart is started by the CPU 202 activating the installer 401 based on an operation by the user. In the description of FIG. 8, steps for performing the same processes as the processes in the flowcharts shown in FIGS. 7A and 7B are assigned the same reference signs, and the description thereof is omitted. That is, the description from S703 to S709 shown in the flowchart of FIG. 8 is omitted.

First, the CPU 202 executes the process of S703. In a case where the button 502 on the initial activation screen 501 is clicked by the user, the CPU 202 executes the processes of S704 and S705. In S801, the CPU 202 determines whether the installation of the vendor driver in S705 has failed or not. If it is determined that the installation of the vendor driver has failed (YES) in S801, the processing proceeds to S802. If not (NO), i.e., it is determined that the installation process has succeeded, the processing proceeds to S706, and the CPU 202 executes the processes from S706 to S708.

In S802, the CPU 202 obtains an error code that may specify the cause of the failure of the installation in S705 output from the OS. In S803, the CPU 202 determines whether the WPP-enabled state is the cause of the failure of the installation or not based on the error code obtained in S802. If it is determined that the WPP-enabled state is the cause (YES) in S803, the processing proceeds to S709, and the CPU 202 executes the process of S709. If not (NO), i.e., it is determined that the WPP-enabled state is not the cause, the processing proceeds to S804. In S804, the CPU 202 displays, on the monitor 201, a general message indicating the failure of the installation. After S804 or S709, the CPU 202 ends the displayed message or the display of the warning notification dialog, based on the predetermined operation by the user or the like, and ends the process of the flowchart shown in FIG. 8, i.e., the execution of the installer 401.

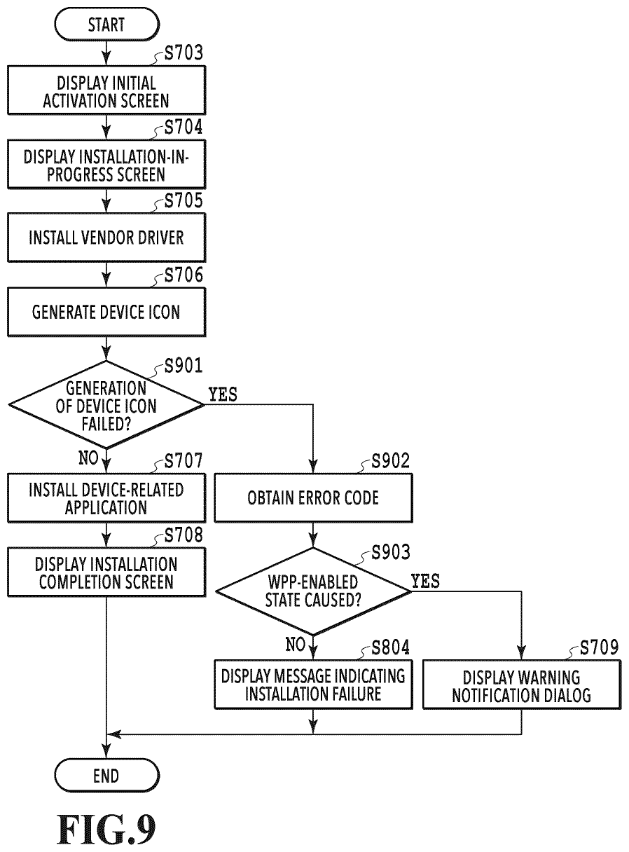

FIG. 9 is a flowchart showing an example of the flow of an installation process using the installer 401 in the PC 101 according to the embodiment 2. Specifically, FIG. 9 shows an example of the processing flow from the activation to completion of the installer 401 in a case where the installation of the vendor driver has succeeded but the subsequent generation of the printer icon may fail. The process of the flowchart is started by the CPU 202 activating the installer 401 based on an operation by the user. Note that in the description of FIG. 9, the description of steps of performing the processes of executing the same processes as the processes in the flowchart shown in FIGS. 7A and 7B, and 8 is omitted. That is, the description from S703 to S708 shown in the flowchart of FIG. 9 is omitted.

First, the CPU 202 executes the process of S703. In a case where the button 502 on the initial activation screen 501 is clicked by the user, the CPU 202 sequentially executes the processes from S704 to S706. In S901, the CPU 202 determines whether the generation of the device icon in S706 has failed or not. If it is determined that the generation of the device icon has failed in S901 (YES), the processing proceeds to S902. If not (NO), i.e., it is determined that the generation of the device icon has succeeded, the processing proceeds to S707, and the CPU 202 executes the processes of S707 and S708.

In S902, the CPU 202 obtains an error code that may specify the cause of the failure of the generation of the printer icon in S706 output from the OS. In S903, the CPU 202 determines whether the WPP-enabled state is the cause of the failure of the generation of the printer icon or not based on the error code obtained in S902. If it is determined that the WPP-enabled state is the cause (YES) in S903, the processing proceeds to S709, and the CPU 202 executes the process of S709. If not (NO), i.e., it is determined that the WPP-enabled state is not the cause (NO), the processing proceeds to S804, and the CPU 202 executes the process of S804. After S804 or S709, the CPU 202 ends the displayed message or the display of the warning notification dialog, based on the predetermined operation by the user or the like, and ends the processing of the flowchart shown in FIG. 8, i.e., the execution of the installer 401.

As described above, it is configured to check whether or not the cause of the failure is the WPP-enabled state, i.e., the state where the installation of the vendor driver is restricted by the OS setting, if the installation of the vendor driver has failed. Accordingly, even without a configuration of specifying whether the WPP is in the enabled state or the disabled state using the API or the like, the user may be notified that the cause of incapability of installation is the state where the installation of the vendor driver is restricted by the OS setting.

Note that in the process of S801, the CPU 202 may determine the failure of the installation in a manner limited to the printer driver. In a case where the WPP may restrict not only the installation of the printer driver but also that of another vendor driver, such as a scanner driver, the CPU 202 may determine the failure of the installation, also with respect to the vendor driver other than the printer driver. Likewise, also in S901 in FIG. 9, the failure of the installation may be determined in a manner limited to the generation of the printer icon. Alternatively, the failure of the installation may be determined, also with respect to the failure of the generation of another device icon.

### Embodiment 3

An embodiment 3 will be described mainly on points different from those in the embodiment 1 or 2. As described above, in the case of WPP, the installation and operation of the vendor driver may be restricted only with respect to the print function. Accordingly, in the present embodiment, an aspect is described that installs the vendor driver and an application that are related to a function other than the print function and are not affected by the restriction by the WPP in a case where the device 102 has a function other than the print function, such as in MFP. Note that in the description of the present embodiment, the same components as those in the embodiment 1 or 2 are assigned the same reference symbols, and the description thereof is omitted.

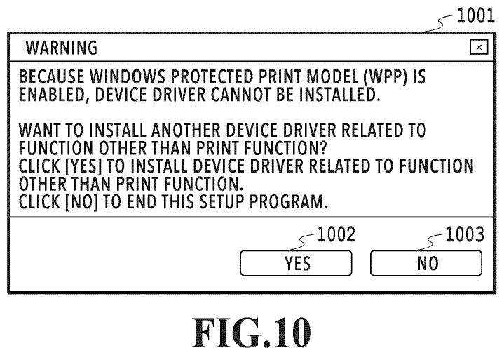

FIG. 10 is a diagram showing an example of a warning notification dialog 1001 displayed on the monitor 201 according to the embodiment 3. Specifically, FIG. 10 shows an example of the warning notification dialog 1001 displayed on the monitor 201 in a case where the WPP is specified to be in the enabled state as the result of the check process by the state check unit 409. In a case where a button 1002 in the warning notification dialog 1001 is clicked by the user, the installer 401 displays the initial activation screen 501 in stead of the warning notification dialog 1001 in a state where the WPP setting is held. In contrast, in a case where a button 1003 in the warning notification dialog 1001 is clicked by the user, the installer 401 closes the warning notification dialog 1001, and ends the predetermined installation process.

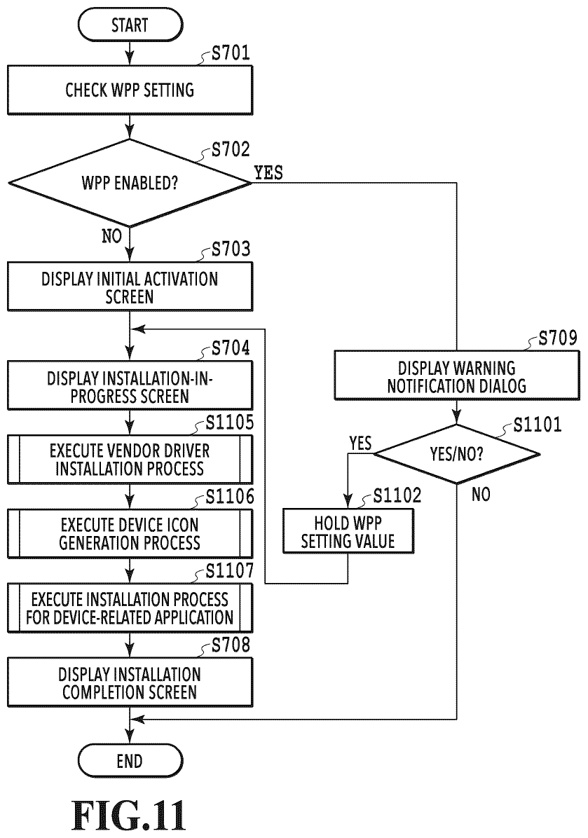

FIG. 11 is a flowchart showing an example of the flow of an installation process using the installer 401 in the PC 101 according to the embodiment 3. Specifically, the flowchart shown in FIG. 11 shows an example of the processing flow from activation to completion of the installer 401. The process of the flowchart is started by the CPU 202 activating the installer 401 based on an operation by the user. In the description of FIG. 11, steps for performing the same processes as the processes in the flowcharts shown in FIGS. 7A and 7B are assigned the same reference signs, and the description thereof is omitted.

First, the CPU 202 executes the processes of S701 and S702. If it is determined that the WPP is in the enabled state in S702 (YES), the processing proceeds to S709, the CPU 202 executes the process of S709, and displays the warning notification dialog 1001. The CPU 202 stands by until the button 1002 or 1103 in the warning notification dialog 1001 is clicked by the user. If not (NO), i.e., it is determined that the WPP is in the disabled state, the processing proceeds to S703, and the CPU 202 executes the processes of S703 and S704. In S1101, the CPU 202 determines whether the button 1002 is clicked or the button 1103 is clicked in the warning notification dialog 1001. If it is determined that the button 1002 (YES) in the warning notification dialog 1001 is clicked by the user in S1101, the processing proceeds to S1102. If it is determined that the button 1003 (NO) in the warning notification dialog 1001 is clicked by the user in S1101, the CPU 202 closes the warning notification dialog 1001, and ends the execution of the installer 401.

In S1102, the CPU 202 holds information related to the WPP setting, i.e., information indicating that the WPP is in the enabled state. Specifically, for example, the CPU 202 temporarily stores the information in the RAM 204 or the like. After S1102, the CPU 202 executes the process of S704, and displays the installation-in-progress screen 503. In S1105, the CPU 202 executes the vendor driver installation process. In S1106, the CPU 202 executes a device icon generation process. In S1107, the CPU 202 executes an installation process for a device-related application. After S1107, the CPU 202 executes the process of S708.

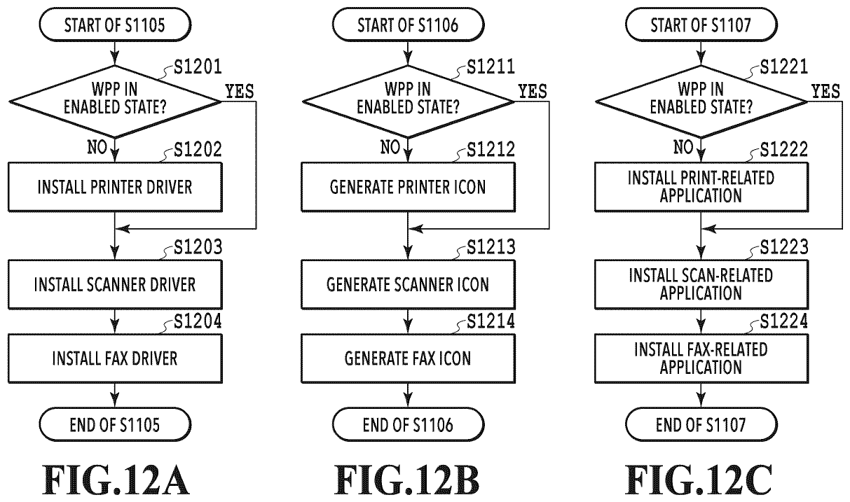

FIGS. 12A to 12C sequentially show examples of the processing flows of the driver installation unit 410, the icon generating unit 411, and the application installation unit 412 according to the embodiment 3. Specifically, FIG. 12A is a flowchart showing an example of the processing flow of the driver installation unit 410, and is a flowchart showing an example of the flow of the device driver installation process in S1105 shown in FIG. 11.

In S1201, the CPU 202 determines whether the WPP is in the enabled state or not based on the information related to the WPP setting held in S1102. If it is determined that the WPP is in the enabled state (YES) in S1201, the processing proceeds to S1203. If it is determined otherwise (NO), i.e., it is determined that the WPP is in the disabled state, the processing proceeds to S1202. In S1202, the CPU 202 installs the printer driver 403, In S1203, the CPU 202 installs the scanner driver 404. In S1204, the CPU 202 installs the fax driver 405. After S1204, the CPU 202 ends the process of the flowchart shown in FIG. 12A, i.e., the process of S1105.

FIG. 12B is a flowchart showing an example of the processing flow of the icon generating unit 411, and is a flowchart showing an example of the flow of the device icon generation process in S1106 shown in FIG. 11. In S1211, the CPU 202 determines whether the WPP is in the enabled state or not based on the information related to the WPP setting held in S1102. If it is determined that the WPP is in the enabled state (YES) in S1211, the processing proceeds to S1213. If it is determined otherwise (NO), i.e., it is determined that the WPP is in the disabled state, the processing proceeds to S1212. In S1212, the CPU 202 generates a printer icon. In S1213, the CPU 202 generates a scanner icon. In S1214, the CPU 202 generates a fax icon. After S1214, the CPU 202 ends the process of the flowchart shown in FIG. 12B, i.e., the process of S1106.

FIG. 12C is a flowchart showing an example of the processing flow of the application installation unit 412, and is a flowchart showing an example of the flow of the installation process for the device-related application in S1107 shown in FIG. 11. In S1221, the CPU 202 determines whether the WPP is in the enabled state or not based on the information related to the WPP setting held in S1102. If it is determined that the WPP is in the enabled state (YES) in S1221, the processing proceeds to S1223. If it is determined otherwise (NO), i.e., it is determined that the WPP is in the disabled state, the processing proceeds to S1222. In S1222, the CPU 202 installs the print-related application 406. In S1223, the CPU 202 installs the scan-related application 407. In S1224, the CPU 202 installs the fax-related application 408. After S1224, the CPU 202 ends the process of the flowchart shown in FIG. 12C, i.e., the process of S1107.

As described above, in a case where the restriction of the installation by the WPP is present, it is configured to install the vendor driver, the device-related application and the like supporting a function that is not affected by the restriction by the WPP among the functions that the device 102 has. Accordingly, in a case where the device 102 is a device having a plurality of functions, such as of MFP, it is effective in comparison with the embodiment 1 or 2. Specifically, in a case where the user intends to use the device 102 for a purpose other than that of the print function with a restriction of installation or use by the WPP, the vendor driver and the device-related application supporting the function other than the print function may be installed.

Note that in the present embodiment, the aspect of skipping the process of installing the printer driver and the print-related application, and the process of generating the printer icon in a case where the WPP is in the enabled state has been described. However, there is no limitation thereto. For example, in a case where the WPP restricts the installation and the like of the vendor driver and the device-related application that support not only the print function but also the fax function, the following configuration may be employed. Specifically, in such a case, it may be configured to skip the process of installing the vendor driver and the device-related application that support the print function and the fax function, and the process of generating the device icon. In the present embodiment, as shown as an example in FIG. 12C, the description has been made assuming that all the print-, scan-, and fax-related applications should be installed. However, there is no limitation thereto. For example, in a case where the vendor does not provide the fax-related application, the installation of the fax-related application is not required to be executed.

### Embodiment 4

An embodiment 4 will be described mainly on points different from those in the embodiments 1 to 3. The present embodiment assumes the following use case as described below. For example, in a case where the user purchases a printer, a CD (Compact Disc) for setup (hereinafter called “setup CD”) may be bundled along with a printer. The setup CD includes an installation package that includes an installer, a device driver (vendor driver) intended to be installed, a device-related application related to a print function or a scan function and the like. Unfortunately, the setup CD includes an old version of the installation package at the time point in a case where the setup CD was manufactured.

Accordingly, the setup CD includes application software for automatically downloading and obtaining the latest version of the installation package to which a function has been added or in which a failure has been corrected, via the external network 105. Description is made below with the application software being called setup application. In the present embodiment, even in a case of installing the vendor driver using the setup application, an aspect of installation in consideration of the WPP setting will be described. Note that in the description of the present embodiment, the same components as those in any one of the embodiments 1 to 3 are assigned the same reference symbols, and the description thereof is omitted.

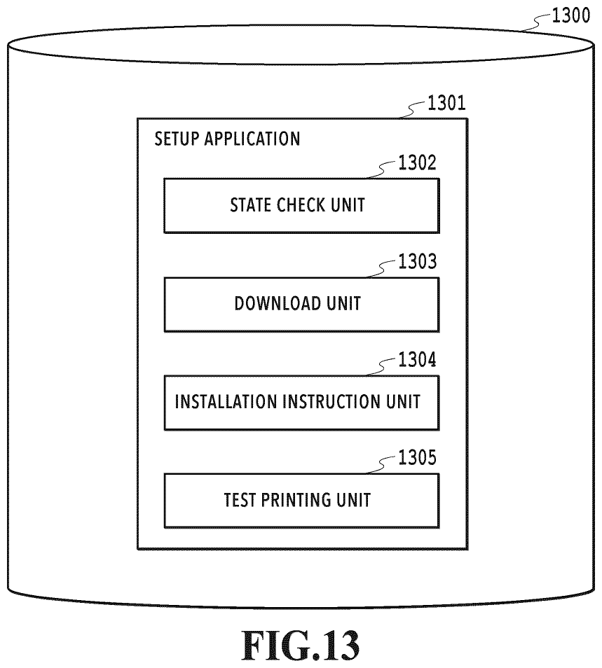

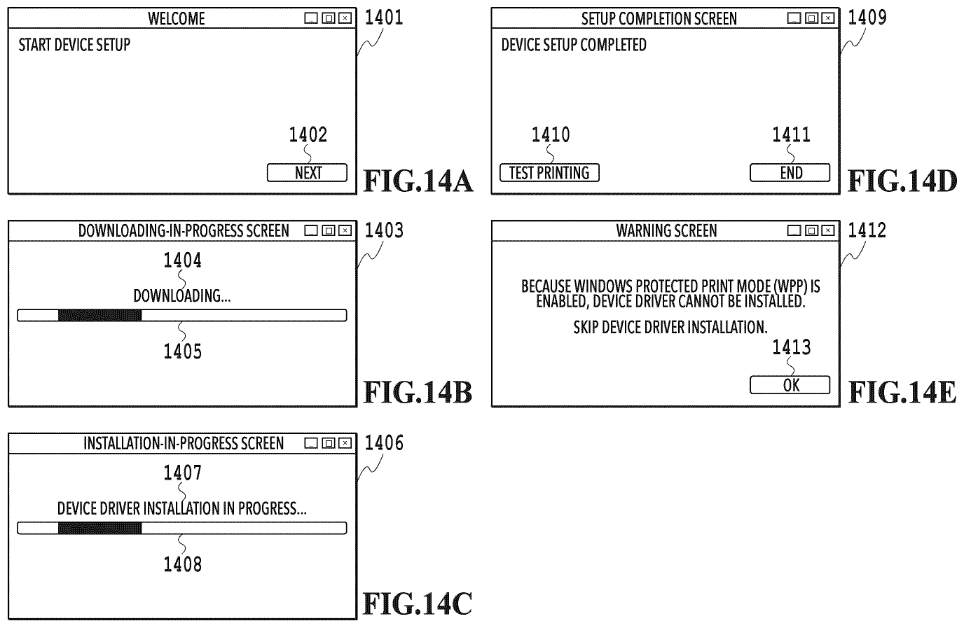

FIG. 13 is a block diagram showing a configuration of a setup application 1301 that supports a device 102 according to the embodiment 4. As shown in FIG. 13, the setup application 1301 is stored in, for example, a setup CD 1300 bundled together in a case where the device 102 is purchased. The setup application 1301 is executed by the CPU 202 to perform processes as described below. The setup application 1301 downloads the installer 401, the vendor drivers 403 to 405, and the device-related applications 406 to 408 that support the device 102 connected to the PC 101, via the external network 105. The setup application 1301 executes the installer 401 obtained by downloading.

The setup application 1301 includes a state check unit 1302, a download unit 1303, an installation instruction unit 1304, and a test printing unit 1305, as functional components. Each component that the setup application 1301 shown as an example in FIG. 13 includes as a functional component is implemented by the CPU 202 reading and executing the setup application 1301 stored in the setup CD 1300.

The state check unit 1302 specifies whether the setting for restricting the installation of the vendor driver is in the enabled state or the disabled state irrespective of the version of the driver, in the OS of the PC 101. A case where the OS of the PC 101 is Windows provided by Microsoft Corp., and the setting is a setting indicating whether the WPP is in the enabled state or the disabled state is described below as an example. That is, in the present embodiment, the state check unit 1302 specifies whether the WPP is in the enabled state or the disabled state. The download unit 1303 downloads the latest installer 401, various vendor drivers 403 to 405, and device-related applications 406 to 408, via the external network 105.

The installation instruction unit 1304 issues an instruction for executing the installer 401 obtained by downloading by the download unit 1303. According to the instruction, the CPU 202 activates and executes the installer 401. According to the execution, the various vendor drivers 403 to 405 and the device-related applications 406 to 408 obtained by downloading by the download unit 1303 are installed. Furthermore, device icons associated with the respective vendor drivers are generated. The test printing unit 1305 executes test printing, based on an operation by the user on the printer icon associated with the installed printer driver 403.

FIGS. 14A to 14E are diagrams showing examples of UI screens according to the embodiment 4. Specifically, FIG. 14A shows an example of an initial activation screen 1401 displayed on the monitor 201 in a case where the setup application 1301 is activated by the CPU 202. The initial activation screen 1401 shown in FIG. 14A is displayed first in a case where the setup application 1301 is activated. FIG. 14B shows an example of a downloading-in-progress screen 1403 displayed in a state where the download unit 1303 is executed by execution of the setup application 1301 by the CPU 202. The downloading-in-progress screen 1403 shown in FIG. 14B is displayed instead of the initial activation screen 1401 in a case where a button 1402 on the initial activation screen 1401 is clicked by the user. The downloading-in-progress screen 1403 includes an internal process status 1404 that is an area for indicating the status of the internal process. For example, while the setup application 1301 is executing the process of the download unit 1303, a message, such as “DOWNLOADING . . . ”, and a progress bar 1405 are displayed at the internal process status 1404.

FIG. 14C is a diagram showing an example of an installation-in-progress screen 1406 displayed in a state where various installation processes by the installer 401 are in execution by the execution of the setup application 1301 by the CPU 202. The installation-in-progress screen 1406 shown in FIG. 14C is displayed instead of the downloading-in-progress screen 1403 while the installer 401 is in execution by the instruction by the installation instruction unit 1304 after the various types of downloading by the download unit 1303 is completed. The installation-in-progress screen 1406 includes an internal process status 1407 that is an area for indicating the status of the internal process. For example, while the installer 401 executed by the instruction by the installation instruction unit 1304 is executing the driver installation unit 410, a message, such as “DRIVER INSTALLATION IN PROGRESS . . . ”, and a progress bar 1408 are displayed at the internal process status 1407.

FIG. 14D shows an example of a setup completion screen 1409 displayed in a case where the various installation processes by the installer 401 are completed. In a case where the various installation processes by the installer 401 are completed, the setup completion screen 1409 shown in FIG. 14D is displayed instead of the installation-in-progress screen 1406 shown in FIG. 14C. In a case where a button 1410 on the setup completion screen 1409 is clicked by the user, the test printing unit 1305 is executed. In a case where a button 1411 on the setup completion screen 1409 is clicked by the user, the setup application 1301 closes the setup completion screen 1409, and ends the predetermined process.

FIG. 14E is a diagram showing an example of a warning screen 1412 displayed in a case where it is detected that the WPP is in the enabled state. In a case where a button 1413 on the warning screen 1412 is clicked by the user, the setup application 1301 skips the processes of the download unit 1303 and the installation instruction unit 1304, and displays the setup completion screen 1409.

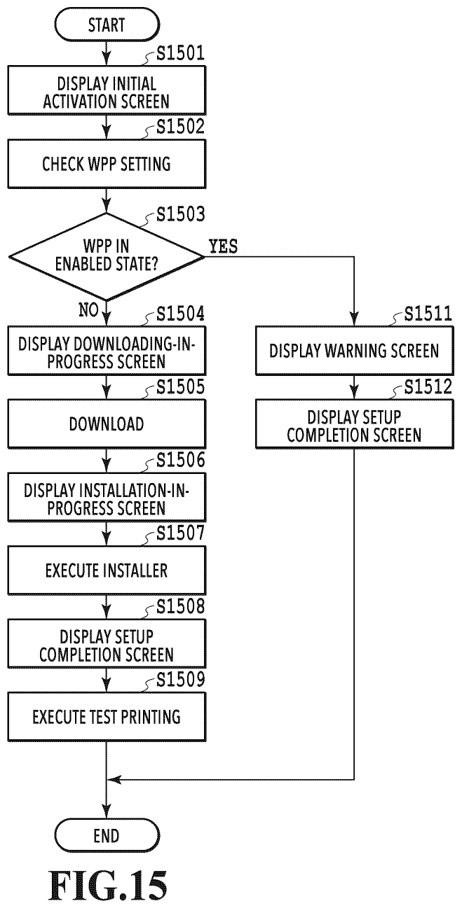

FIG. 15 is a flowchart showing an example of a processing flow from activation to completion of the setup application 1301 in the PC 101 according to the embodiment 4. The process of the flowchart is started by the CPU 202 activating the setup application 1301 based on an operation by the user. In S1501, the CPU 202 displays the initial activation screen 1401. Subsequently, the CPU 202 stands by until the button 1402 on the initial activation screen 1401 is clicked by the user. In a case where the button 1402 on the initial activation screen 1401 is clicked by the user, the processing proceeds to S1502.

In S1502, the CPU 202 checks the WPP setting, and specifies whether the WPP is in the enabled state or the disabled state. Note that the check process of S1501 is implemented by the CPU 202 executing the state check unit 1302 included in the setup application 1301. In S1503, the CPU 202 determines whether the WPP is in the enabled state or not based on the result of the check process of S701. If it is determined that the WPP is in the enabled state (YES) in S1503, the processing proceeds to S1511. If it is determined otherwise (NO), i.e., it is determined that the WPP is in the disabled state, the processing proceeds to S1504.

In S1504, the CPU 202 displays the downloading-in-progress screen 1403 instead of the initial activation screen 1401. In S1505, the CPU 202 downloads the installer 401, the vendor drivers 403 to 405, and the device-related applications 406 to 408. Note that the downloading in S1505 is implemented by the CPU 202 executing the download unit 1303 included in the setup application 1301. In S1506, the CPU 202 displays the installation-in-progress screen 1406 instead of the downloading-in-progress screen 1403. In S1507, the CPU 202 installs the vendor drivers 403 to 405 and the like by executing the installer 401 downloaded in S1505 based on the instruction by the installation instruction unit 1304. Note that the instruction by the installation instruction unit 1304 in S1507 is implemented by the CPU 202 executing the installation instruction unit 1304 included in the setup application 1301.

In S1508, the CPU 202 brings the state into a clickable state where the button 1410 for executing test printing is displayed or the like, and displays the setup completion screen 1409 instead of the installation-in-progress screen 1406. In S1509, the CPU 202 performs the test printing. The test printing in S1509 is implemented by the CPU 202 executing the test printing unit 1305 included in the setup application 1301 in a case where the button 1410 on the setup completion screen 1409 is clicked by the user. In a case where the button 1411 on the setup completion screen 1409 is clicked by the user, the CPU 202 closes the setup completion screen 1409, and ends the process of the flowchart shown in FIG. 15, i.e., the execution of the setup application 1301. Note that in a case where the button 1411 is clicked by the user before the button 1410 on the setup completion screen 1409 is clicked by the user, the process of S1509 is skipped.

In S1511, the CPU 202 displays the warning screen 1412 instead of the initial activation screen 1401. The CPU 202 stands by until the button 1413 on the warning screen 1412 is clicked by the user. In a case where the button 1413 on the warning screen 1412 is clicked by the user, the processing proceeds to S1512. In S1512, the CPU 202 brings the button 1410 for executing test printing into a non-clickable state, such as a hidden state, and displays the setup completion screen 1409 instead of the warning screen 1412. In a case where the button 1411 on the setup completion screen 1409 is clicked by the user, the CPU 202 closes the setup completion screen 1409, and ends the process of the flowchart shown in FIG. 15, i.e., the execution of the setup application 1301.

As described above, in the case of using the setup application 1301, it is configured to check whether the WPP is in the enabled state, i.e., whether it is in a state where the installation of the vendor driver is restricted by the OS setting irrespective of the version. Specifically, it is configured to perform the check before the process of downloading the installer 401 and the like and the process for installing the vendor drivers 403 to 405 and the like are executed. It is configured to skip the downloading process and the installation process in a case where the WPP is in the enabled state, i.e., in a case where the installation of the vendor driver is restricted by the OS setting irrespective of the version, in the check.

Accordingly, in the case of the state where the installation of the vendor driver is restricted by the OS setting irrespective of the version, the communication cost for downloading files, such as the installer 401, can be reduced. In this case, the user's standby time required to download the files, such as the installer 401, can be reduced. Note that the larger the size of the file to be downloaded is, the longer the user's standby time period is. If the user recognized at the first time that the installation of the vendor driver is impossible after the completion of the downloading process, unnecessary standby time is imposed on the user. The standby time may be prevented from occurring by checking whether the installation of the vendor driver is in a state restricted by the OS setting irrespective of the version before the process of downloading the installer 401 and the like is executed.

It is configured to switch between displaying and hiding a UI component for executing a function of utilizing the vendor driver, such as test printing, on the setup completion screen 1409, based on whether the utilization of the vendor driver is restricted depending on the settings of the WPP and the like by the OS or not.

In the present embodiment, the description is made assuming that the setup application 1301 includes a functional block for downloading and installing the vendor driver, and a functional block for performing the test printing using the installed vendor driver. However, the configuration of the setup application 1301 is not limited thereto. For example, the setup application 1301 may have various setup functions, such as a setup of the main body of the device 102, and connection support between the device 102 and the PC through a network, a USB cable or the like. The setup of the main body of the device 102 is mounting of an ink tank or the like in a case where the device 102 is a printer. In the case where the setup application 1301 has the various setup functions as described above, this increases the operation time period related to the setup of the device 102 by the user. However, as with the present embodiment, the operation time period may be reduced by preliminarily grasping that the installation of the vendor driver is restricted or the utilization of the vendor driver is restricted, based on the settings of the WPP and the like.

In the present embodiment, the example of skipping the installation processes for the vendor driver and the device-related application that support all the functions that the device 102 has is described. However, there is no limitation thereto. For example, as in the embodiment 3, the setup application 1301 may be configured so as to skip only the downloading of the print-related printer driver and the print-related application among the functions that the device 102 has. In this case, the setup application 1301 is configured such that in the installer 401, only the installation of the printer driver and the print-related application whose downloading has been skipped are skipped. Accordingly, the vendor drivers and the device-related applications that support the scan function, the fax function and the like that are functions other than the print function are downloaded and installed.

In this case, for example, the warning screen 1412 may be configured so as to present that only the vendor drivers and the device-related applications supporting the scan function, the fax function and the like that are functions other than the print function are installed. For example, the warning screen 1412 may be configured so as to allow the user to choose whether to install the vendor drivers and the device-related applications supporting the functions other than the print function or not. If the user chooses to install the vendor drivers and the device-related applications supporting a function other than the print function, only the vendor drivers and the device-related applications are downloaded and installed in the subsequent process.

### Embodiment 5

An embodiment 5 will be described mainly on points different from those in the embodiments 1 to 4. In the present embodiment, an aspect of installing the followings instead of installing the vendor driver is described. Specifically, the device driver provided by the OS vendor (hereinafter called “standard driver”), and a PSA provided by a third party such as the vendor of the device 102 (hereinafter called “vendor-made PSA”), are installed. The same components as those in the embodiment 1 to 4 are assigned the same reference signs, and the description thereof is omitted.

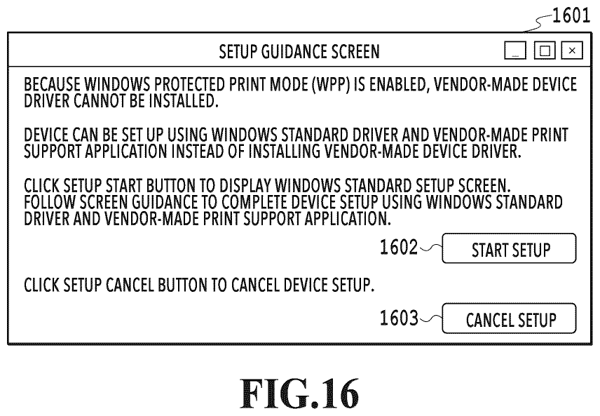

FIG. 16 is a diagram showing an example of a UI screen according to the embodiment 5. Specifically, FIG. 16 shows an example of a guidance screen 1601 displayed on the monitor 201 by executing the setup application 1301 in a case where the WPP is in the enabled state and the vendor-made PSA may be installed. The guidance screen 1601 includes, for example, messages indicating that the vendor driver (hereinafter also called “vendor-made driver”) cannot be installed, and the standard driver and the vendor-made PSA may be installed instead of the vendor driver.

In a case where a button 1602 on the guidance screen 1601 is clicked by the user, the setup application 1301 displays a standard printer setup screen (hereinafter called “standard setup screen”), such as Add Printer Wizard, provided by the OS vendor. The user sets up the device 102 using the standard driver and the vendor-made PSA according to the guidance on the standard setup screen. Specifically, the setup of the device 102 is performed by executing the installation of the standard driver, and the downloading and installation of the vendor-made PSA. By setting up the device 102 using the standard setup screen, the printer icon corresponding to the standard driver is generated.

In a case where the setup application 1301 detects the generation of the printer icon, the setup application 1301 displays the setup completion screen 1409. In this case, the setup application 1301 brings the state into a clickable state, such as a state where the button 1410 for executing test printing on the setup completion screen 1409 is displayed, and displays the setup completion screen 1409. If the setup application 1301 cannot detect the generation of the printer icon, the setup application 1301 brings the button 1410 into a non-clickable state, such as a hidden state, and displays the setup completion screen 1409. In a case where a button 1603 on the guidance screen 1601 is clicked by the user, the setup application 1301 displays the setup completion screen 1409 where button 1410 is in the non-clickable state, such as the hidden state, instead of the guidance screen 1601.

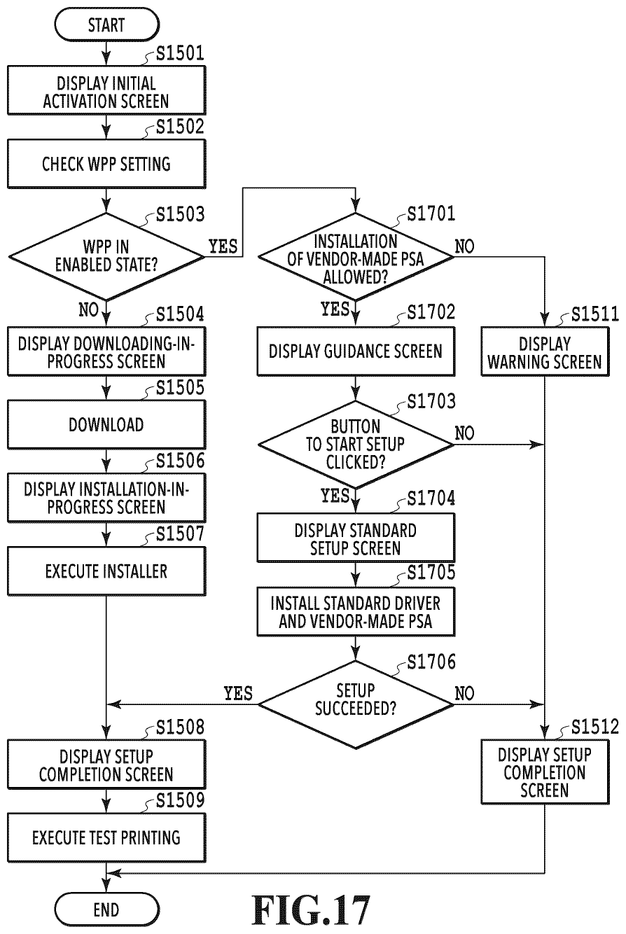

FIG. 17 is a flowchart showing an example of a processing flow from activation to completion of the setup application 1301 in the PC 101 according to the embodiment 5. The process of the flowchart is started by the CPU 202 activating the setup application 1301 based on an operation by the user. In the description of FIG. 17, the same processes as the processes of the flowchart shown in FIG. 15 are assigned the same reference signs, and the description thereof is omitted. First, the CPU 202 executes the processes from 1501 to S1503. If it is determined that the WPP is in the enabled state (YES) in S1503, the processing proceeds to S1701. If not (NO), i.e., it is determined that the WPP is in the disabled state, the processing proceeds to S1504, and the CPU 202 executes the processes from S1504 to S1509.

In S1701, the CPU 202 determines whether the installation of the vendor-made PSA is allowed or not. If it is determined that the installation is allowed (YES) in S1701, the processing proceeds to S1702. If not (NO), i.e., it is determined that the installation process is not allowed, the processing proceeds to S1511, and the CPU 202 executes the processes of S1511 and S1512. In S1702, the CPU 202 displays the guidance screen 1601. The CPU 202 stands by until the button 1602 or 1603 on the guidance screen 1601 is clicked by the user. In a case where either the button 1602 or 1603 on the guidance screen 1601 is clicked, the processing proceeds to S1703. In S1703, the CPU 202 determines whether the button 1602 for starting the setup of the guidance screen 1601 is clicked or not. If it is determined that the button 1602 is clicked (YES) in S1703, the processing proceeds to S1704. If not (NO), i.e., it is determined that the button 1603 for stopping the setup is clicked, the processing proceeds to S1512, and the CPU 202 executes the process of S1512.

In S1704, the CPU 202 displays the standard setup screen. The user performs an operation according to guidance on the standard setup screen. In S1705, the CPU 202 installs the standard driver and the vendor-made PSA based on the operation on the standard setup screen by the user, thereby setting up the device 102. In S1706, the CPU 202 determines whether the setup of the device 102 using the standard driver and the vendor-made PSA has succeeded or not. If it is determined that the setup has succeeded in S1706 (YES), the processing proceeds to S1508, and the CPU 202 executes the processes of S1508 and S1509. If not (NO), i.e., it is determined that the setup has failed, the processing proceeds to S1512, and the CPU 202 executes the process of S1512.

As described above, in the case of using the setup application 1301, it is configured to guide the setup of the device 102 using the standard driver and the vendor-made PSA in a case where the WPP is in the enabled state and the vendor driver cannot be installed. Accordingly, even in the state where the WPP is left enabled, i.e., the state where the installation of the vendor driver is left restricted by the OS setting irrespective of the version, the user may utilize the function that the device 102 has using the PC 101. Note that in the present embodiment, the description is made assuming that in a case where the setup is stopped, or the setup using the standard driver and the vendor-made PSA fails, the button 1410 is brought into the non-clickable state, such as the hidden state, and the setup completion screen 1409 is displayed. However, in these cases, the operation is not limited to that described above. For example, in these cases, a screen indicating that the setup has failed may be displayed. Furthermore, the screen may be provided with a UI component, such as a button, for re-execution from display of the initial activation screen 1401 by the setup application 1301.

### Embodiment 6

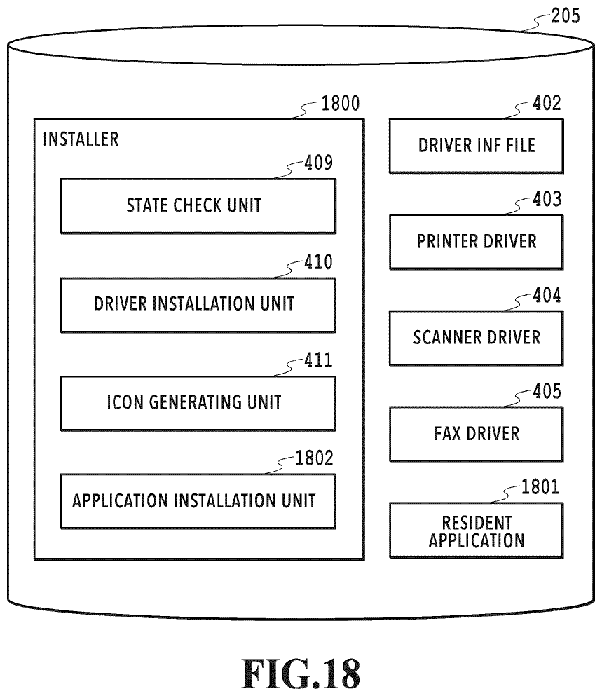

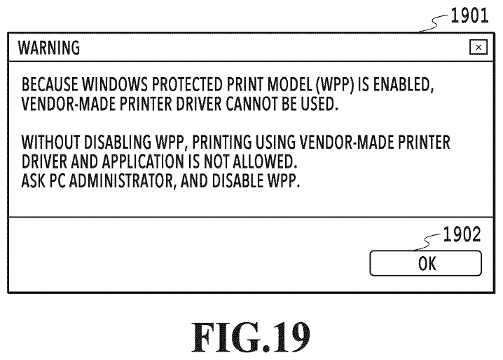

An embodiment 6 will be described with reference to FIGS. 18 to 21. The present embodiment assumes the following use case as described below. For example, this is a case where after the user installs the vendor driver in the PC 101, and subsequently, the default setting of the WPP is switched from disabled to be enabled by the automatic update system of the OS, such as Windows Update. In such a case, although printing has been allowed using the vendor driver so far, the printing using the vendor driver becomes disabled irrespective of the user's intention. In the present embodiment, an aspect of notifying the user that the printing using the vendor driver becomes disabled in the use case as described above is described. In the description in the present embodiment, the same components as those in the embodiments 1 to 5 are assigned the same reference symbols, and the description thereof is omitted.

FIG. 18 is a block diagram showing an example of software that pertains to the device 102 and is stored in the auxiliary storage device 205 that the PC 101 according to the embodiment 6 includes. As shown as an example in FIG. 18, the auxiliary storage device 205 included in the PC 101 stores an installer 1800, a driver INF file 402, a printer driver 403, a scanner driver 404, and a fax driver 405. The auxiliary storage device 205 stores a resident application 1801.

The resident application 1801 is application software that is executed by the CPU 202 to check whether the WPP is in the enabled state or not periodically or irregularly in a period of the execution. In a case where it is detected that the WPP is in the enabled state, the resident application 1801 notifies the user that the function of the device 102 cannot be utilized using the vendor driver because the WPP is in the enabled state.

The installer 1800 includes the state check unit 409, the driver installation unit 410, the icon generating unit 411, and an application installation unit 1802, as the functional components. The application installation unit 1802 is implemented by the CPU 202 executing the installer 1800, and is installed in a case where the OS supports the WPP function, and the WPP is in the disabled state.

FIG. 19 is a diagram showing an example of a warning notification dialog 1901 displayed on the monitor 201 according to the embodiment 6. The warning notification dialog 1901 shown in FIG. 19 is displayed by the CPU 202 executing the resident application 1801. The warning notification dialog 1901 includes messages indicating that the utilization of the vendor driver is restricted by the OS depending on the WPP setting and the like and that the function of the device 102 cannot be utilized using the vendor driver in a case where the OS setting such as of the WPP is not changed. In a case where a button 1902 in the warning notification dialog 1901 is clicked by the user, the CPU 202 closes the warning notification dialog 1901, and ends the execution of the resident application 1801.

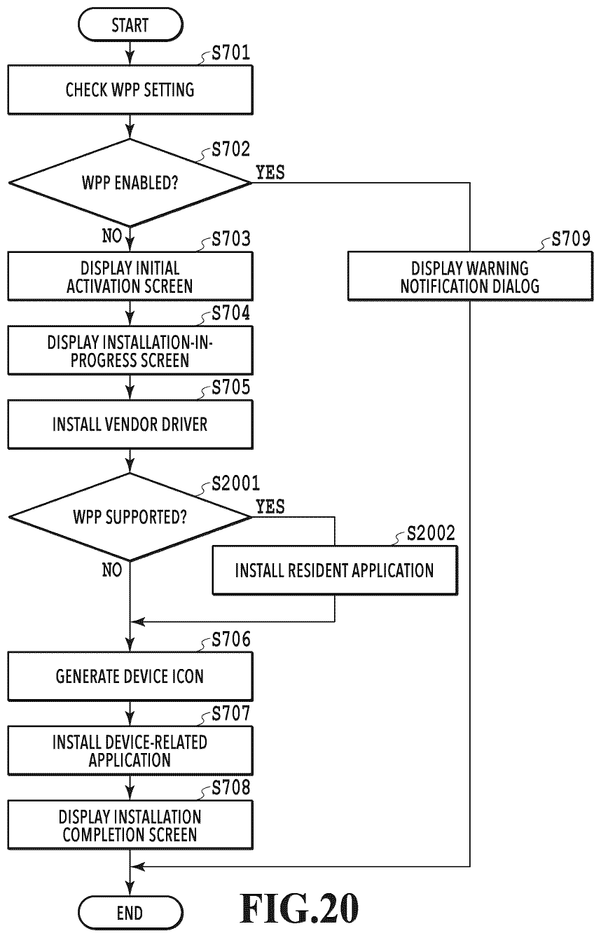

FIG. 20 is a flowchart showing an example of a processing flow from activation to completion of the installer 1800 in the PC 101 according to the embodiment 6. The process of the flowchart is started by the CPU 202 activating the installer 1800 based on an operation by the user. In the description of FIG. 20, the same processes as the processes in the flowcharts shown in FIGS. 7A and 7B are assigned the same reference signs, and the description thereof is omitted. First, the CPU 202 executes the processes of S701 and S702. If it is determined that the WPP is in the enabled state in S702 (YES). the processing proceeds to S709, the CPU 202 executes the process of S709, and displays the warning notification dialog 601 or 603. If not (NO), i.e., it is determined that the WPP is in the disabled state, the processing proceeds to S703, and the CPU 202 executes the processes from S703 to S705.

In S2001, the CPU 202 determines whether or not the OS supports the function, such as the WPP, of restricting the use of the vendor driver. If it is determined that it is supported (YES) in S2001, the processing proceeds to S2002. If not (NO), i.e., it is determined that it is not supported, the processing proceeds to S706, and the CPU 202 executes the processes from S706 to S708. In S2002, the CPU 202 installs the resident application 1801. The installation of the resident application 1801 is implemented by the CPU 202 executing the application installation unit 1802 included in the installer 1800. After S2002, the CPU 202 executes the processes from S706 to S708.

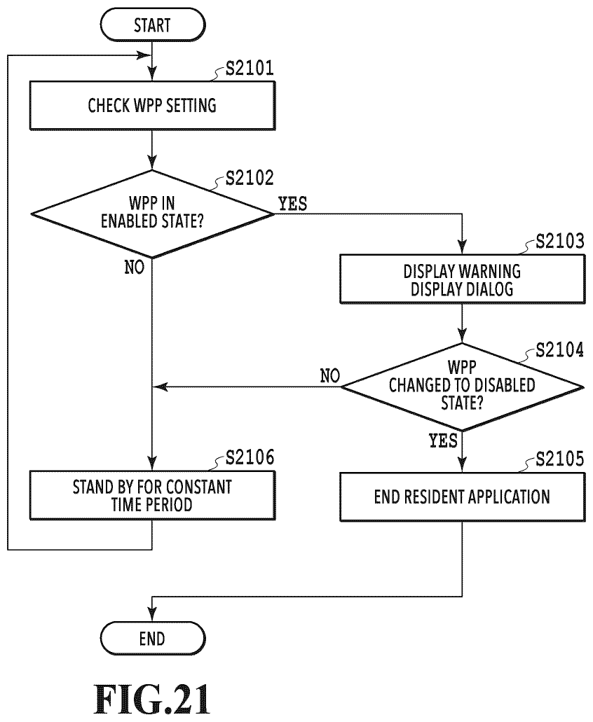

FIG. 21 is a flowchart showing an example of the processing flow of the resident application 1801 installed in the PC 101 according to the embodiment 6. The process of the flowchart is started by the CPU 202 detecting the startup function of the OS in a case where the PC is activated, and activating the resident application 1801. In S2101, the CPU 202 checks the WPP setting, and specifies whether the WPP is in the enabled state or the disabled state. In S2102, the CPU 202 determines whether the WPP is in the enabled state or not. If it is determined that the WPP is in the enabled state (YES) in S2101, the processing proceeds to S2103. If it is determined otherwise (NO), i.e., it is determined that the WPP is in the disabled state, the processing proceeds to S2106.

In S2103, the CPU 202 displays the warning notification dialog 1901. In a case where the button 1902 in the warning notification dialog 1901 is clicked by the user, the CPU 202 closes the warning notification dialog 1901. In S2104, the CPU 202 determines whether the WPP is changed from the enabled state to the disabled state. If it is determined that the setting of the WPP is changed from the enabled state to the disabled state (YES) in S2104, the processing proceeds to S2105. If it is determined otherwise (NO), i.e., it is determined that the WPP is left in the enabled state, the processing proceeds to S2106. In S2105, the CPU 202 ends the resident application 1801, and ends the process of the flowchart shown in FIG. 21. In S2106, the CPU 202 stands by for a constant time period, such as an hour. After S2016, the CPU 202 returns the processing to S2101.

As described above, it is configured to install the resident application 1801 that checks whether the utilization of the vendor driver is restricted by the OS depending on the setting of the WPP and the like. Accordingly, even if the WPP is switched to the enabled state irrespective of the user's intention after the vendor driver is installed, it may be notified that the utilization of the vendor driver is restricted by the OS.

Note that in the present embodiment, for instance, the resident application 1801 installed by the execution of the installer 1800 is described as an example. However, there is no limitation thereto. For example, the print-related application 406 installed by the execution of the installer 401 may have a function similar to that of the resident application 1801. In this case, the print-related application 406 operates as resident application software that is always in operation during the OS operation.

### Other Embodiments

In each of the embodiments described above, for instance, the WPP of Windows is described as an example. However, there is no limitation to the WPP. This is also applicable to another OS that has a function similar to that of the WPP.

Note that various types of control described above assuming that the control is performed by the CPU 202 may be performed by one piece of hardware. Alternatively, multiple pieces of hardware, such as processors or processing circuits, may share the processing, thereby controlling the entire apparatus.

The technique of the present disclosure has been described in detail based on the suitable embodiments. However, the technique in the present disclosure is not limited to these specific embodiments. Various embodiments in a range without departing the gist of the present disclosure are also encompassed by the technique in the present disclosure. Furthermore, each embodiment described above only indicates one embodiment of the technique in the present disclosure. Each embodiment may be combined as appropriate.

In the embodiments described above, the case of applying the technique in the present disclosure to the PC (personal computer) has been described as an example. The application is not limited to this example. Specifically, it is applicable to any apparatus where a vendor driver may be installed, or an OS with an installed vendor driver operates. The apparatuses to which the technique in the present disclosure is applicable include not only the PC but also a server device, a PDA (Personal Digital Assistant), a mobile phone terminal such as a smartphone, a mobile image viewer, an image forming apparatus, a digital photo frame, a music player, a game machine, an electronic book reader, and an imaging apparatus.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, in an environment where a restriction related to the vendor driver may be applied depending on the OS setting, the user may suitably perform an operation.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-138884, filed on Aug. 20, 2024, which is hereby incorporated by reference herein in its entirety.

What is claimed is:

1. A non-transitory computer readable storage medium storing a program for causing a computer to perform a control method of controlling an information processing apparatus on which an operating system operates, the operating system having a setting function of setting whether to enable a specific print mode as a function of the operating system, and a restriction function of restricting installation of software for providing a print function different from a print function by the operating system in a case where the specific print mode is set to be enabled, the program being for installing specific software for providing the print function different from the print function by the operating system in the information processing apparatus, the control method comprising the steps of:
performing control to install the specific software in the information processing apparatus in a case where an operation for installing the specific software is performed by a user and the specific print mode is set to be disabled; and
performing control to display a specific notification on the restriction relating to the specific software in a case where the operation for installing the specific software is performed by a user and the specific print mode is set to be enabled.

2. The storage medium according to claim 1, wherein the control method further comprises the steps of:
referring to information indicating whether the specific print mode is enabled or not; and
performing control based on the information referred to.

3. The storage medium according to claim 1, wherein the control method further comprises the step of
performing control to display the specific notification without installing the specific software.

4. The storage medium according to claim 1, wherein the control method further comprises the step of
performing control to display the specific notification, based on a failure to install the specific software.

5. The storage medium according to claim 4, wherein the control method further comprises the step of
performing control to display the specific notification, based on the failure to install the specific software because of the specific print mode being enabled.

6. The storage medium according to claim 1, wherein
the specific notification indicates that installation is impossible.

7. The storage medium according to claim 6, wherein
the specific notification indicates that the installation is impossible because the specific print mode is enabled.

8. The storage medium according to claim 7, wherein
the specific notification includes encouragement for disabling the specific print mode.

9. The storage medium according to claim 8, wherein
the specific notification includes content indicating a solution that a user is supposed to apply to disable the specific print mode.

10. The storage medium according to claim 1, wherein the control method further comprises the step of
performing control to set the specific print mode to disabled, in response to an operation on a specific display item included in the specific notification.

11. The storage medium according to claim 1, wherein
the specific notification includes content about execution of setup other than what is related to printing.

12. The storage medium according to claim 1, wherein the control method further comprises the step of
performing control to display the specific notification, based on a failure to perform a predetermined process pertaining to installation of the specific software.

13. The storage medium according to claim 1, wherein the control method further comprises the step of
performing control to install second software for providing a function different from the print function without performing a predetermined process pertaining to installation of the specific software, in a case where the operation for installing the specific software is present and the specific print mode is set to be enabled.

14. The storage medium according to claim 13, wherein
the second software is at least one of a scanner driver and a fax driver.

15. The storage medium according to claim 1, wherein
the specific notification includes content indicating that the print function by the operating system is usable.

16. The storage medium according to claim 15, wherein
the specific notification includes at least one of content indicating that use of vendor-made support software for supporting the print function by the operating system is allowed, and content for performing setup for allowing the use.

17. A non-transitory computer readable storage medium storing a program for causing a computer to perform a control method of controlling an information processing apparatus on which an operating system operates, the operating system having a setting function of setting whether to enable a specific print mode as a function of the operating system, and a restriction function of restricting an operation by software for providing a print function different from a print function by the operating system in a case where the specific print mode is set to be enabled, and in which specific software for providing the print function different from the print function by the operating system is installed, the control method comprising the steps of:
referring to information indicating whether the specific print mode is enabled or not; and
performing control to display a predetermined notification about the restriction relating to the specific software, in response to a change in setting of the specific print mode from disabled to be enabled as a result of the reference.

18. The storage medium according to claim 17, wherein
the predetermined notification indicates that printing using the specific software is impossible.

19. The storage medium according to claim 18, wherein
the predetermined notification indicates that the printing using the specific software is impossible because the specific print mode is enabled.

20. The storage medium according to claim 19, wherein
the predetermined notification includes encouragement for disabling the specific print mode.

21. The storage medium according to claim 20, wherein
the specific notification includes content indicating a solution that a user is supposed to apply to disable the specific print mode.

22. The storage medium according to claim 17, wherein
the program is installed along with the specific software.

23. The storage medium according to claim 22, wherein
the program is not installed in a case where the specific software is installed in an information processing apparatus on which an operating system that does not have the function of the specific print mode operates.

24. The storage medium according to claim 17, wherein
the program operates as resident application software in a state where the operating system is in operation in the information processing apparatus.

25. An information processing apparatus on which an operating system operates, the operating system having a setting function of setting whether to enable a specific print mode as a function of the operating system, and a restriction function of restricting installation of software for providing a print function different from a print function by the operating system in a case where the specific print mode is set to be enabled, the information processing apparatus comprising:
at least one memory and at least one processor which function as:
an installation unit configured to install the specific software for providing a print function different from the print function by the operating system, wherein
the installation unit includes:
an installation control unit configured to perform control to install the specific software in the information processing apparatus in a case where an operation for installing the specific software is performed by a user and the specific print mode is set to be disabled; and
a display control unit configured to perform control to display a specific notification on the restriction relating to the specific software in a case where the operation for installing the specific software is performed by a user and the specific print mode is set to be enabled.

26. A method of controlling an information processing apparatus on which an operating system operates, the operating system having a setting function of setting whether to enable a specific print mode as a function of the operating system, and a restriction function of restricting installation of software for providing a print function different from a print function by the operating system in a case where the specific print mode is set to be enabled, the method comprising the steps of:
installing the specific software for providing the print function different from the print function by the operating system;
performing control to install the specific software in the information processing apparatus in a case where an operation for installing the specific software is performed by a user and the specific print mode is set to be disabled; and
performing control to display a specific notification on the restriction relating to the specific software in a case where the operation for installing the specific software is performed by a user and the specific print mode is set to be enabled.

27. An information processing apparatus on which an operating system operates, the operating system having a setting function of setting whether to enable a specific print mode as a function of the operating system, and a restriction function of restricting an operation by software for providing a print function different from a print function by the operating system in a case where the specific print mode is set to be enabled, and in which specific software for providing the print function different from the print function by the operating system is installed, the information processing apparatus comprising:
at least one memory and at least one processor which function as:
a reference unit configured to refer to information indicating whether the specific print mode is enabled or not; and
a control unit configured to perform control to display a predetermined notification about the restriction relating to the specific software, in response to a change in setting of the specific print mode from disabled to be enabled as a result of the reference by the reference unit.

28. A method of controlling an information processing apparatus on which an operating system operates, the operating system having a setting function of setting whether to enable a specific print mode as a function of the operating system, and a restriction function of restricting an operation by software for providing a print function different from a print function by the operating system in a case where the specific print mode is set to be enabled, and in which specific software for providing the print function different from the print function by the operating system is installed, the method comprising the steps of:
referring to information indicating whether the specific print mode is enabled or not; and
performing control to display a predetermined notification about the restriction relating to the specific software, in response to a change in setting of the specific print mode from disabled to be enabled as a result of the reference.
